(19) United States
(12) Patent Application Publication
(10) Pub. No.: US 2004/0247991 A1
(43) Pub. Date: Dec. 9, 2004

(54) Electrode for fuel cell, manufacturing method thereof, and fuel cell

(75) Inventors: Takenobu Suzuki, Nagoya-shi (JP); Mikio Sugiura, Toyota-shi (JP); Gang Xie, Anjo-shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: AISIN SEIKI KABUSHIKI KAISHA, Aichi-ken (JP)

(21) Appl. No.: 10/803,933

(22) Filed: Mar. 19, 2004

(30) Foreign Application Priority Data
Mar. 19, 2003 (JP) 2003-075889

(51) Int. Cl. H01M 4/86; H01M 4/94

(52) U.S. Cl. 429/44

(57) ABSTRACT

An electrode for fuel cell assembled to a solid polymer electrolyte membrane includes catalyst carrier particles, catalyst retaining particles formed by retaining a catalyst at the catalyst carrier particles, and a plurality of catalyst layers including the catalyst retaining particle. An aggregate average particle diameter of the catalyst carrier particle of the catalyst layer contacting the solid polymer electrolyte membrane is smaller than a aggregate average particle diameters of the catalyst carrier particle of other catalyst layers.

This application is based on and claims priority under 35 U.S.C. § 119 with respect to Japanese Patent Application No. 2003-075889 filed on Mar. 19, 2003, the entire contents of which are incorporated herein by reference.

### FIELD OF THE INVENTION

The present invention relates to a fuel cell. More particularly, the present invention pertains to an electrode for a fuel cell, a manufacturing method for the electrode for the fuel cell, and the fuel cell.

### BACKGROUND OF THE INVENTION

A proton-exchange membrane fuel cell includes an anode, a cathode, and a solid polymer electrolyte membrane. A membrane-electrode unit serving as a base of the fuel cell is constructed by sandwiching the solid polymer electrolyte membrane between the anode and the cathode to be bound by hot pressing, or the like. The anode and the cathode generally include a porous catalyst layer provided on a surface of an electric conductive porous support layer (i.e., gas diffusion layer member) such as a carbon paper.

The catalyst layer is configured to be a sheet made of the catalyst layer paste produced by dispersing catalyst retaining particles which is formed by retaining the catalyst at catalyst carrier particles such as carbon black and a polymer electrolyte in a dispersion medium. In the catalyst layer, elements in which the catalyst retaining particles are covered with the polymer electrolyte are aggregated. The entire surface of the catalyst retaining particle may be covered with the polymer electrolyte and a part of the surface of the catalyst retaining particle may be covered with the polymer electrode depending on an amount of the polymer electrolyte. The fuel cell generates the electric power by an electrode reaction at the catalyst layer. More particularly, the electrode reaction is caused at a three-phase interface between the catalyst, the polymer electrolyte, and the reactant (i.e., the fuel such as the hydrogen, methanol, and the hydro carbon at the anode and the oxygen at the cathode).

One of the conditions required for the fuel cell electrode is that the electric current is obtained at high electric current density. Compared to the known fuel cell such as the phosphoric acid type fuel cell operated at 150-250 mA/cm², the proton-exchange membrane fuel cell is required to operate at the electric current density approximate 10 times of the phosphoric acid type fuel cell. In order to attain the operation at the high electric current density and the long-term stable operation, the catalyst elements and the retaining method of the catalyst elements, or the like, have been studied.

Japanese Patent Laid-Open Publication No. H08-227716 describes a known construction material for an electrode of a fuel cell including an aggregate of the carrier catalyst particles having two peaks of particle diameters.

Japanese Patent Laid-Open Publication No. H09-265992 describes a known construction of an electrode of a fuel cell in which the catalyst density shows the maximum value at the interface with the electrolyte.

Japanese Patent Laid-Open Publication No. 2001-345110 describes a known fuel cell including a first catalyst layer provided at a solid polymer electrolyte membrane and a second catalyst layer provided at a gas diffusion layer. The first catalyst layer and the second catalyst layer are stacked to be positioned opposite to each other.

Notwithstanding, the spatial distribution of the aggregate particle diameter of the catalyst carrier particles in the catalyst layer has not been studied in the known fuel cells. With Japanese Patent Laid-Open Publication No. H08-227716, although that the aggregate of the retaining carrier particles used for the catalyst layer includes two particle diameter distribution peak is described, the spatial distribution of the aggregate particle diameter of the catalyst carrier particles is not described. With Japanese Patent Laid-Open Publication No. H09-265992, although that the catalyst density includes the maximum value at the interface with the electrolyte is described, the spatial distribution of the aggregate particle diameter of the catalyst carrier particles (e.g., the carbon black) for retaining the catalyst is not described. With Japanese Patent Laid-Open Publication No. 2001-345110, although that the arrangement of the first catalyst layer and the second catalyst layer stacked opposite to each other is described, the spatial distribution of the aggregate particle diameter of the catalyst carrier particles is not described because the same catalyst carrier particles (e.g., carbon black) are used for the first catalyst layer and the second catalyst layer.

Known fuel cells do not disclose the details of the spatial distribution of the aggregate particle diameter of the catalyst carrier particles in the catalyst layer by controlling the particle size distribution (i.e., a first particle diameter) of the catalyst carrier particles and the particle size distribution (i.e., a second particle diameter) of the aggregate of the catalyst carrier particles and the influences thereof relative to the electrode activation.

A need thus exists for an electrode for a fuel cell, a manufacturing method for the electrode for the fuel cell, and the fuel cell, which attain the high performance by considering the spatial distribution of the aggregate particle diameter of the catalyst carrier particle.

### SUMMARY OF THE INVENTION

In light of the foregoing, the present invention provides an electrode for fuel cell assembled to a solid polymer electrolyte membrane which includes catalyst carrier particles, catalyst retaining particles formed by retaining a catalyst at the catalyst carrier particles, and a plurality of catalyst layers including the catalyst retaining particle. An aggregate average particle diameter of the catalyst carrier particle of the catalyst layer contacting the solid polymer electrolyte membrane is smaller than a aggregate average particle diameters of the catalyst carrier particle of other catalyst layers.

According to another aspect of the present invention, a manufacturing method of an electrode for fuel cell includes a first process for forming a first catalyst layer including catalyst retaining particles including catalyst carrier particles retained with a catalyst, and a second process for forming a second catalyst layer including catalyst retaining particles including catalyst carrier particles retained with the catalyst on the first catalyst layer, the catalyst carrier particles including an aggregate average particle diameter smaller than an aggregate average particle diameter of the catalyst carrier particles of the first catalyst layer.

According to still another aspect of the present invention, a fuel cell includes an anode provided at a first side of a solid polymer electrolyte membrane, and a cathode provided at a second side of the solid polymer electrolyte membrane. At least one of the anode and the cathode includes catalyst carrier particles, catalyst retaining particles formed by retaining a catalyst at the catalyst carrier particles, and a plurality of catalyst layers including the catalyst retaining particle. An aggregate average particle diameter of the catalyst carrier particle of the catalyst layer contacting the solid polymer electrolyte membrane is smaller than a aggregate average particle diameters of the catalyst carrier particle of other catalyst layers.

According to still further aspect of the present invention, a fuel cell includes an anode provided at a first side of a solid polymer electrolyte membrane, and a cathode provided at a second side of the solid polymer electrolyte membrane. At least one of the anode and the cathode is manufactured by a method including a first process for forming a first catalyst layer including catalyst retaining particles including catalyst carrier particles retained with a catalyst, and a second process for forming a second catalyst layer including catalyst retaining particles including catalyst carrier particles retained with the catalyst on the first catalyst layer. The catalyst carrier particles including an aggregate average particle diameter is smaller than an aggregate average particle diameter of the catalyst carrier particle of the first catalyst layer.

### BRIEF DESCRIPTION OF THE DRAWING FIGURES

The foregoing and additional features and characteristics of the present invention will become more apparent from the following detailed description considered with reference to the accompanying drawing figures in which like reference numerals designate like elements.

FIG. 1 shows a cross sectional view of a membrane electrode assembly of a proton-exchange membrane fuel cell according to first and second embodiments of the present invention.

FIG. 2 shows an exploded cross sectional view of the membrane electrode assembly for explaining a manufacturing process of the first embodiment.

FIG. 3 shows an exploded cross sectional view of the membrane electrode assembly for explaining a manufacturing process of the second embodiment.

FIG. 4 shows a cross sectional view of a membrane electrode assembly of a proton-exchange membrane fuel cell of a comparative example.

FIG. 5 shows an exploded cross sectional view of the membrane electrode assembly for explaining a manufacturing method for the comparative example.

FIG. 6 shows an approximate cross sectional view for explaining a construction of a cell 100 for the proton-exchange membrane fuel cell according to the embodiments of the present invention.

FIG. 7 is a graph showing evaluation results of the first embodiment, the second embodiment, and the comparative example.

### DETAILED DESCRIPTION OF THE INVENTION

With catalyst carrier particles having too fine aggregate particle diameter, a small bore diameter assumes too small to smoothly discharge the excessive water and to smoothly supply the reaction gas, which deteriorates the characteristics of the fuel cell to reduce the production of the energy amount. In the meantime, in case the aggregate particle diameter of the catalyst carrier particle is too large, the number of the catalysts provided at the surface of the aggregate particle is reduced. In this case, the catalyst utilization ratio corresponding to the ratio of the catalyst contributing to the electrode reaction among the catalyst included in the catalyst layer is reduced to reduce the output of the fuel cell. In addition, with too large aggregate particle diameter of the catalyst carrier particle, the thickness of the polymer electrolyte covering the catalyst retaining particle is increased. As a result, the amount of the catalyst to which the reaction material reaches is reduced to decline the catalyst utilization ratio, thus to decline the output of the fuel cell.

The influence of the spatial distribution of the aggregate particle diameter of the catalyst carrier particle to the fuel cell performance has studied to obtain the high performance proton-exchange membrane fuel cell.

Embodiments of the present invention will be explained with reference to the illustrations of the drawing figures as follows.

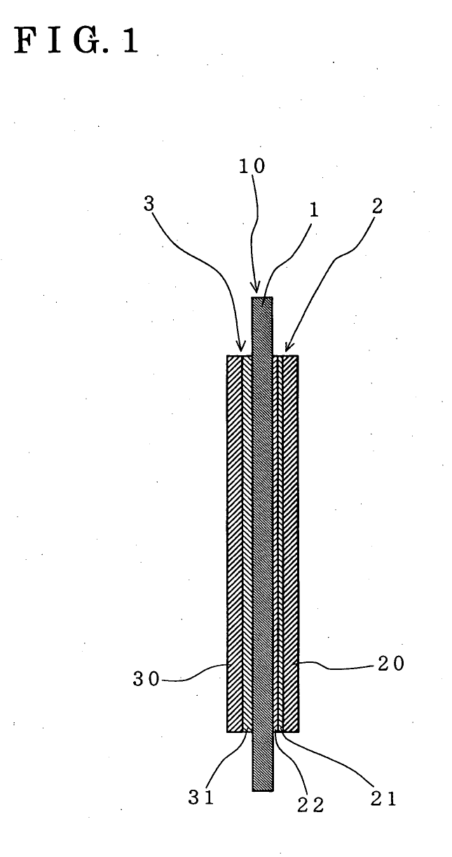

As shown in FIG. 1, a membrane electrode assembly 10 is produced by sandwiching a solid polymer electrolyte membrane 1 between a cathode 2 and an anode 3 to be assembled. The cathode 2 and the anode 3 correspond to the electrodes for the fuel cell. The electric power is generated by supplying the fuel to the cathode 2 and supplying the oxygen to the anode 3.

The cathode 2 includes a gas diffusion layer member 20, a first catalyst layer 21, and a second catalyst layer 22. The first catalyst layer 21 is formed at one side surface of the gas diffusion layer member 20. The second catalyst layer 22 is stacked on the first catalyst layer 21. The cathode 2 is assembled with the solid polymer electrolyte membrane 1 so that the second catalyst layer 22 is arranged facing the solid polymer electrolyte membrane 1. The anode 3 includes a gas diffusion layer member 30 and a catalyst layer 31. The catalyst layer 31 is formed at one side surface of the gas diffusion layer member 30. The anode 3 is assembled to the solid polymer electrolyte member 31 so that the catalyst layer 31 is arranged facing the solid polymer electrolyte membrane 1.

Having generally described this invention, a further understanding can be obtained by reference to certain specific examples which are provided herein for purposes of illustration only and are not intended to be limiting unless otherwise specified.

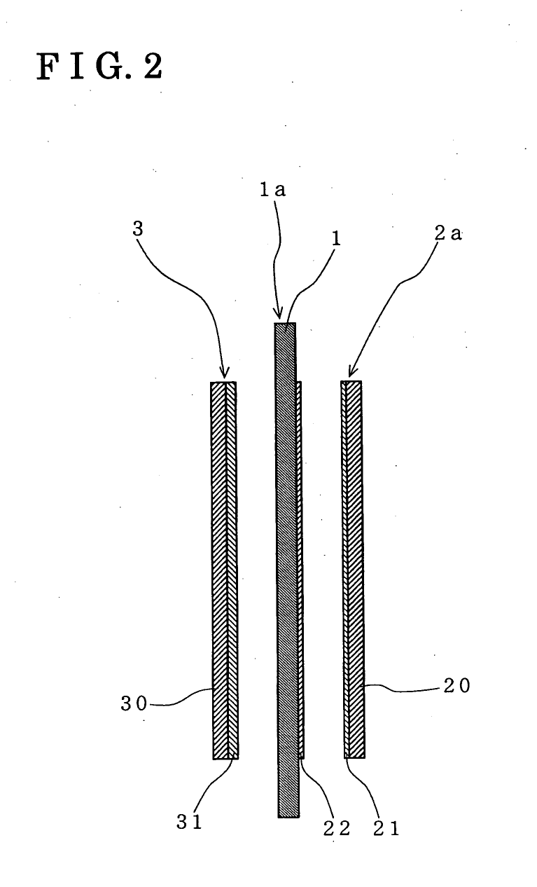

Carbon black may be used as catalyst carrier particles for the first catalyst layer 21, the second catalyst layer 22, and the catalyst layer 31 shown in FIG. 2. Platinum is used as the catalyst. Platinum catalyst retaining carbon (Johnson Matthey Japan Incorporated: Hispec 4000) including carbon black retaining 40 weight percent of platinum may be used as the catalyst retaining particle. Carbon paper (Toray Industries Inc.: TGP-H-060; thickness of 0.18 mm) including the gas diffusiveness and the electric conductivity may be used as the base material for the gas diffusion layer members 20, 30. GORE-SELECT (having the thickness of 45 μm) made by Japan GORE-TEX Inc. having a dimension of 130 mm by 170 mm may be used as the solid polymer electrolyte membrane 1.

The paste for the first catalyst layer is manufactured in the following process. First, platinum catalyst retaining carbon, water, alcohol dispersion liquid of the polymer electrolyte (Asahi Kasei Corporation: Aciplex SS-1080), and isopropyl alcohol (referred as IPA hereafter) are mixed with weight ratio of 1:2.1:15:1.9. Thereafter, the mixed liquid is dispersed with a ball mill so that the aggregate average particle diameter of the platinum catalyst retaining carbon becomes 10 μm.

The aggregate average particle diameter of the platinum catalyst retaining carbon is measured using a laser diffraction type particle size distribution measurement device (HORIBA Ltd.: LA-500). More particularly, after mixing the first catalyst layer paste in ethanol of approximate 5 cm³, the mixed liquid of the first catalyst layer paste and the ethanol is put into a sampling chamber provided with ethanol of the laser diffraction type particle size distribution measurement device. The aggregate average particle diameter of the platinum catalyst retaining carbon is measured by adjusting the mixed liquid to a predetermined concentration. The average diameter is shown with the median size. The following aggregate average particle diameter is measured likewise the foregoing manner.

Because the aggregate average particle diameter is adjusted when producing the catalyst paste, the aggregate average particle diameter of the platinum catalyst retaining carbon is measured in this case. The aggregate of the platinum catalyst retaining carbon includes the aggregate of the carbon black corresponding to the catalyst carrier particles which retains the platinum catalyst. Because the size of the platinum catalyst is much smaller than the size of the aggregate of the carbon black, the aggregate average particle diameter of the platinum catalyst retaining carbon is approximately the same with the aggregate average particle diameter of the catalyst carrier particle. Thus, it is more practical to measure the aggregate average particle diameter of the platinum catalyst retaining carbon (i.e., catalyst retaining particle).

The paste for the second catalyst layer is manufactured in the following process. First, platinum catalyst retaining carbon, water, alcohol dispersion liquid of the polymer electrolyte (Asahi Kasei Corporation: Aciplex SS-1080), and the isopropyl alcohol (referred as IPA hereafter) are mixed with the weight ratio 1:2.1:15:1.9 likewise the first catalyst layer. Thereafter, the mixed platinum catalyst retaining carbon, water, alcohol dispersion liquid of the polymer electrolyte, and the isopropyl alcohol is dispersed with a ball mill so that the aggregate average particle diameter of the platinum catalyst retaining carbon becomes 0.5 μm to produce the second catalyst layer paste. The aggregate average particle diameter is adjusted by the dispersion with the ball mill in accordance with the rotational number and the transaction time of the ball mill.

A carbon paste (i.e., having the viscosity measured by the rotating viscometer: 1600 mPa·s (20° C.; rotational speed 100/sec)) is created by dispersing a carbon powder (i.e., carbon 100 parts by weight: PTFE 75 parts by weight) applied with the water repellent treatment using the aqueous PTFE dispersion (DAIKIN INDUSTRIES, Ltd.: D-1), the dispersant, and the thicker dispersed in the water. A carbon powder layer applied with the water repellent treatment is formed by applying the carbon paste at one surface of the carbon paper cut into the size having the dimension of 200 mm by 250 mm. Thereafter, the carbon powder layer is dried to produce the gas diffusion layer member 20. In this embodiment, the carbon corresponds to the boron modified acetylene black. In the embodiment, the aggregate average particle diameter of the carbon powder is equal to or smaller than 0.5 μm. The application amount of the carbon powder is 4-5 mg/cm².

After applying the first catalyst layer paste on the carbon powder layer of the gas diffusion layer member 20 using an applicator (i.e., doctor blade method) so that the platinum amount of the first catalyst layer paste assumes 0.3 mg/cm², the first catalyst layer paste at the gas diffusion layer member 20 is dried at 60° C. to form the first catalyst layer 21, and to manufacture a cathode intermediate member 2a (i.e., a first process for manufacturing the cathode 2).

Likewise the gas diffusion layer member 20, the water resistant gas diffusion layer member 30 is manufactured. After applying the first catalyst layer paste on the carbon powder layer of the gas diffusion layer member 30 using the application so that the platinum amount assumes 0.4 mg/cm², the first catalyst layer paste at the gas diffusion layer member 30 is dried at 60° C. to form the catalyst layer 31 to manufacture the anode 3.

After applying the second catalyst layer paste at one side surface of an ethylene-tetrafluoroethylene copolymer resin film (referred as ETFE hereafter) using the applicator so that the platinum amount assumes 0.1 mg/cm², the second catalyst layer paste at the ETFE copolymer resin film is dried at 60° C. to form the second catalyst layer 22. The ETFE formed with the second catalyst layer 22 and the solid polymer electrolyte membrane 1 are arranged to face each other so that the second catalyst layer 22 contacts the solid polymer electrolyte 1 and maintained at the temperature of 150° C. and at the pressure of 9.8 MPa (100 kg/cm²) for one minute to form the second catalyst layer 22 at one side of the solid polymer electrolyte 1 by decal transferring, thus to manufacture a membrane-second catalyst layer assembly 1a.

The cathode intermediate member 2a, the membrane-second catalyst layer assembly 1a, and the anode 3 are stacked as shown in FIG. 2. The first catalyst layer 21 of the cathode intermediate member 2a and the second catalyst layer 22 of the membrane-second catalyst layer assembly 1a are arranged facing each other and the solid polymer electrolyte membrane 1 of the membrane-second catalyst layer assembly 1a and the catalyst layer 31 of the anode 3 are arranged to face each other to be maintained at the temperature of 140° C., at the pressure of 7.8 MPa (80 kg/cm²) for three minutes to assemble the cathode intermediate member 2a, the membrane-second catalyst layer assembly 1a, and the anode 3, and thus to manufacture the membrane electrode assembly 10. A second process for manufacturing the cathode 2 of the first embodiment starts from the process for forming the second catalyst layer 22 on one surface of the ETFE and ends at the process for manufacturing the membrane electrode assembly 10.

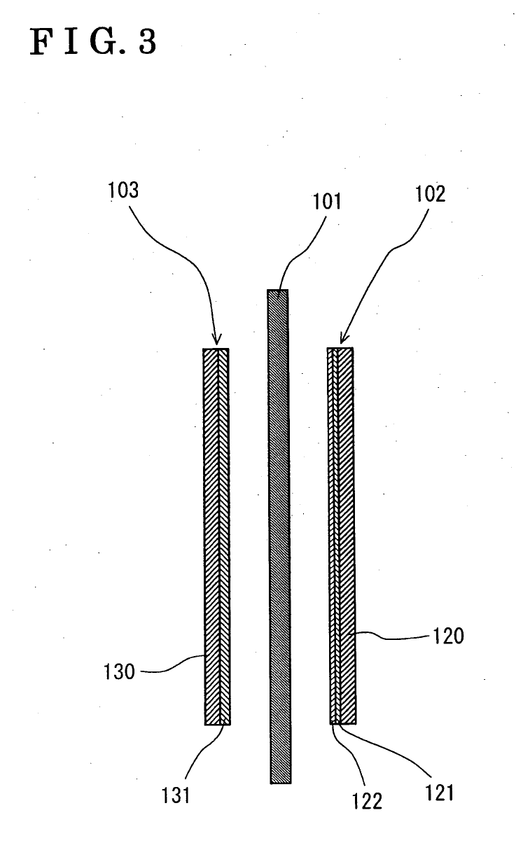

A second embodiment of the present invention will be explained with reference to FIG. 3 as follows. In the second embodiment, the same materials to the first embodiment are used for the catalyst carrier particles, the catalyst, and the catalyst retaining particles to produce the first catalyst paste and the second catalyst paste likewise the first embodiment. Gas diffusion layer members 120, 130 are manufactured likewise the first embodiment.

After applying the first catalyst layer paste on the carbon powder layer of the gas diffusion layer member 120 using the applicator so that the platinum amount assumes 0.3 mg/cm², the first catalyst layer paste at the gas diffusion layer member 120 is dried at 60° C. to form a first catalyst layer 121 (i.e., the first process for manufacturing a cathode 102). After applying the second catalyst layer paste on the first catalyst layer 121 using the applicator so that the platinum amount assumes 0.1 mg/cm², the second catalyst layer paste is dried at 60° C. to from a second catalyst layer 122 (i.e., the second process for manufacturing the cathode 102) to produce the cathode 102.

An anode 103 of the second embodiment is produced likewise in the first embodiment. After applying the first catalyst paste on the carbon powder layer of a gas diffusion layer member 130 using the applicator so that the platinum amount assumes 0.4 mg/cm², the first catalyst paste at the gas diffusion layer member 130 is dried at 60° C. to form a catalyst layer 131 to produce the anode 103.

A solid polymer electrolyte membrane 101 is sandwiched between the cathode 102 and the anode 103. The second catalyst layer 122 of the cathode 102 and the catalyst layer 131 of the anode 103 contact the solid polymer electrolyte membrane 101 as shown in FIG. 3 and maintained at the temperature of 140° C., at the pressure of 7.8 MPa (80 kg/cm²), for three minutes to assemble the solid polymer electrolyte membrane 101, the cathode 102, and the anode 103, thus to produce a membrane electrode assembly (i.e., corresponding to the membrane electrode assembly 10 of the first embodiment).

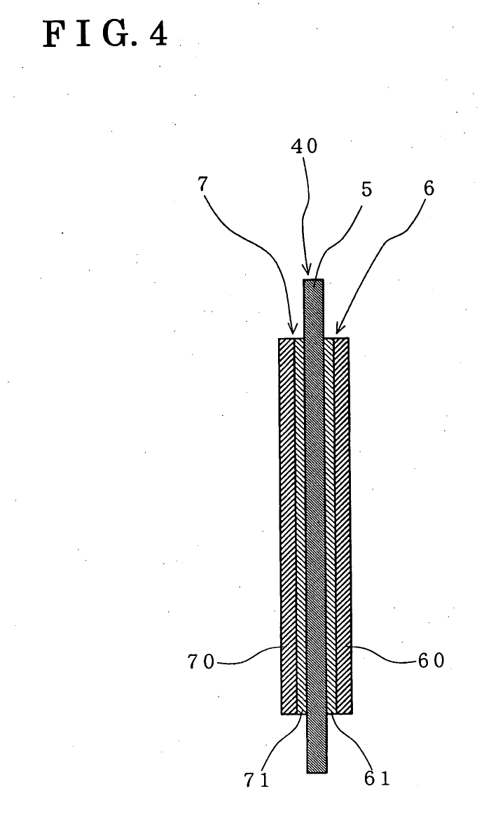

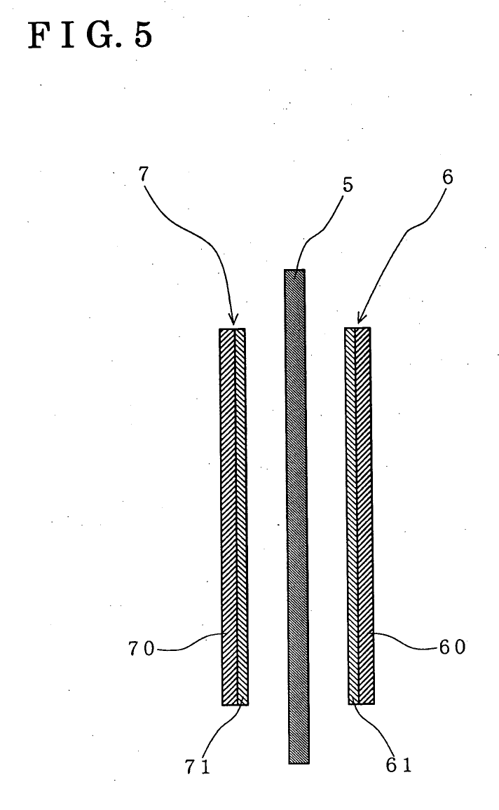

A comparative example is configured and produced as shown in FIGS. 4-5 and is explained as follows.

A membrane electrode assembly 40 is produced by sandwiching a solid polymer electrolyte membrane 5 between a cathode 6 and an anode 7 to be assembled. The cathode 6 includes a gas diffusion layer member 60 and a catalyst layer 61. The catalyst layer 61 is stacked on one surface of the gas diffusion layer member 60. The cathode 6 is assembled to the solid polymer electrolyte membrane 5 so that the catalyst layer 61 faces the solid polymer electrolyte membrane 5. The anode 7 includes a gas diffusion layer member 70 and a catalyst layer 71. The catalyst layer 71 is stacked on one surface of the gas diffusion layer member 70. The anode 7 is assembled to the solid polymer electrolyte membrane 5 so that the catalyst layer 71 faces the solid polymer electrolyte membrane 5.

The same materials with the first embodiment are used for the catalyst carrier particles, the catalyst, and the catalyst retaining particle. The catalyst layer paste of the comparison example is produced likewise the first catalyst paste of the first embodiment. Gas diffusion layer members 60, 70 are produced likewise the gas diffusion layer member 20 of the first embodiment.

After applying the catalyst layer paste on the carbon powder layer of the gas diffusion layer member 60 using the applicator so that the platinum amount assumes 0.4 mg/cm², the catalyst layer paste at the gas diffusion layer member 60 is dried at 60° C. to form the catalyst layer 61 to produce the cathode 6. Likewise, after applying the catalyst layer paste on the carbon powder layer of the gas diffusion layer member 70 using the applicator so that the platinum amount assumes 0.4 mg/cm², the catalyst layer paste at the gas diffusion layer member 70 is dried at 60° C. to form the catalyst layer 71 to produce the anode 7.

Thereafter, the solid polymer electrolyte membrane 5 is sandwiched between the cathode 6 and the anode 7. The catalyst layer 61 of the cathode 6 and the catalyst layer 71 of the anode 7 contact the solid polymer electrolyte membrane 5 and maintained at the temperature of 140° C. and at the pressure of 7.8 MPa (80 kg/cm²) for three minutes to assemble the solid polymer electrolyte membrane 5, the cathode 6, and the anode 7, thus to produce the membrane-electrolyte assembly 40.

A proton exchange membrane type fuel cell 100 is produced by sandwiching the membrane electrode assembly between a pair of separators including gas passages for supplying the oxidization gas and the fuel gas respectively.

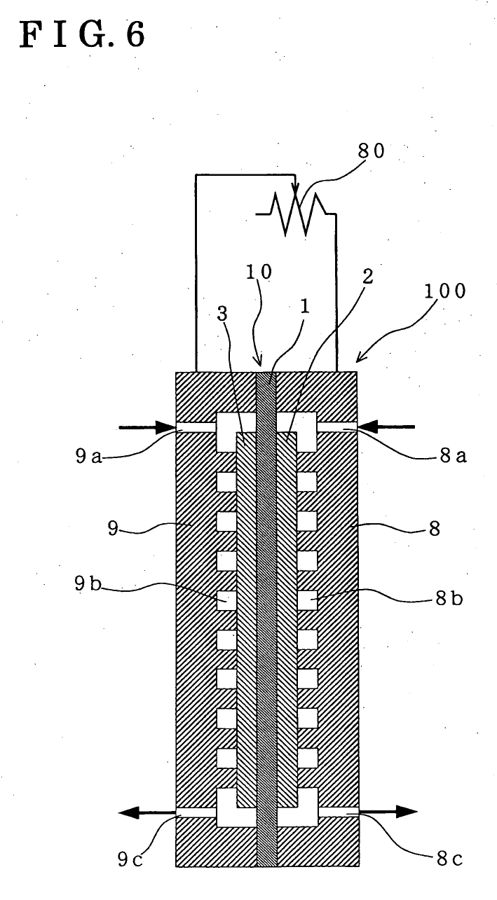

With the proton exchange membrane type fuel cell 100, the membrane electrode assembly 10 is sandwiched between the separators 8, 9 as shown in FIG. 6. The separator 8 includes an oxidant gas passage groove 8b for supplying the oxidant gas to the cathode 2. The oxidant gas supplied from an oxidant gas supply port 8a passes through the oxidant gas passage groove 8b to be exhausted from an oxidant gas exhaust port 8c. The separator 9 includes a fuel gas passage groove 9b for supplying the fuel gas to the anode 3. The fuel gas supplied from a fuel gas supply port 9a passes through the fuel gas passage groove 9b to be exhausted from a fuel gas exhaust port 9c.

The temperature of the proton exchange membrane type fuel cell 100 is determined at 78° C. The air (oxygen utilization ratio 50%) is supplied to the cathode 2 at two atmosphere and the hydrogen (hydrogen utilization ratio 80%) is supplied to the hydrogen at two atmosphere. Supplying the water vapor by the falling-drop method moisturizes the air and the hydrogen. The air is moisturized with the following ratio relative to the vapor: vapor/air=0.14 (molar ratio). The hydrogen is moisturized with the following ratio relative to the vapor: vapor/hydrogen=0.1 (molar ratio). The generated electricity is taken from the electric terminal of the separator 8 and the separator 9. The resistance of the generated electricity is changed by an external variable resistance 80 to measure the electric current density and the cell electric voltage for the evaluation.

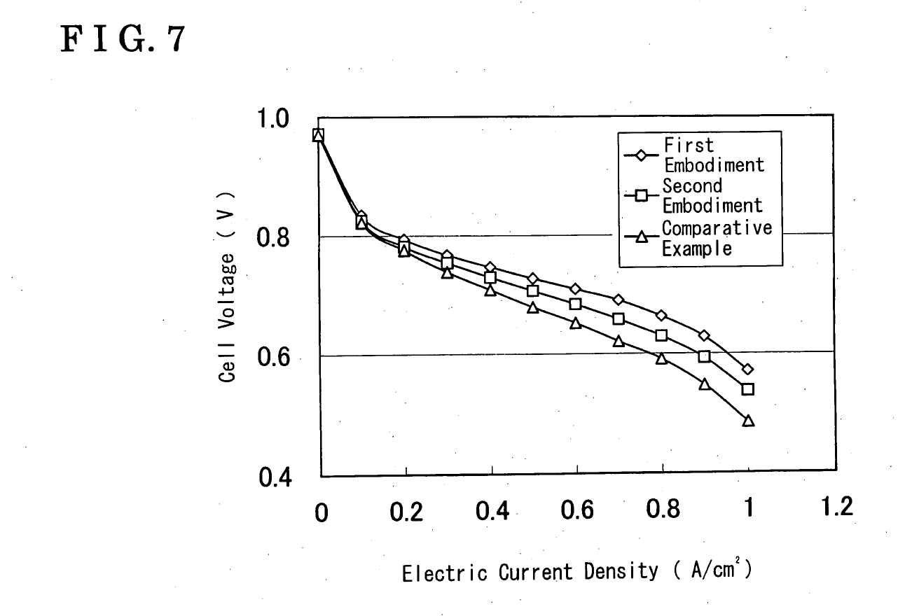

The evaluation results are shown in FIG. 7. The graph in FIG. 7 shows the relationship between the electric current density and the cell electric voltage of each cell. As shown in FIG. 7, higher cell electric voltage can be obtained with the proton exchange membrane type fuel cell 100 including the first and the second embodiments than the proton exchange membrane type fuel cell 100 including the comparative example. At the electric current density 1.0 A/cm², the cell electric voltage of the first embodiment is higher than the comparative example by approximately 80 mV and the cell electric voltage of the second embodiment is higher than the comparative example by approximately 45 mV.

Because the aggregate particle diameter of the catalyst carrier particle is large at the first catalyst layer 21 to configure small bores to have large diameter, which provides high gas diffusion performance and high discharging performance of the excessive water. Thus, the air supplied to the oxidant gas passage groove 8b is diffused into the second catalyst layer 22 and the vapor from the second catalyst layer 22 is swiftly discharged into the oxidant gas passage groove 8b. In the meantime, because the aggregate particle diameter of the catalyst carrier particle is small at the second catalyst layer 22, the ratio of the platinum catalyst provided at the surface of the catalyst retaining particle is large to attain the high catalyst activation. With the construction of the first and the second embodiments of the present invention, the high gas diffusion performance and the high discharging performance of the excessive water is attained by the second catalyst layer 22 and the high catalyst activation is attained by the first catalyst layer 21. Thus, high cell electric voltage is attained.

Accordingly, by providing the multiple layers of the catalyst layer of the fuel cell electrode and by determining the size of the aggregate average particle diameter of the catalyst carrier particle of the catalyst layer contacting the solid polymer electrolyte membrane to be smaller than the aggregate average particle diameter of other catalyst layer, the high catalyst activation is attained at the catalyst layer contacting the solid polymer electrolyte membrane approximate to the membrane-electrode interface where the electrode reaction is caused. Moreover, by attaining the diffusion performance of the gas and the water at other catalyst layers, the reactant can be supplied to the membrane-electrode interface swiftly to quickly discharge the generated water at the membrane-electrode interface. This provides the high performance fuel cell.

Comparing the first embodiment and the second embodiment, the higher cell electric voltage is attained with the first embodiment. With the construction of the first embodiment, because the catalyst layer is formed at the ETFE sheet having smoother surface than the carbon paper and transferring method is used for producing the second catalyst layer, the second catalyst layer of the first embodiment includes smoother surface than the second embodiment. Thus, because the temperature and the pressure applied when assembling the solid polymer electrolyte membrane 1 and the second catalyst layer 22 can be high to produce the membrane electrode assembly 10, the cohesiveness between the catalyst layer and the membrane is increased to improve the fuel cell performance.

Although the catalyst layer of the first and the second embodiments include two layers, the catalyst layer may include three layers or more layers. In case of having three layers or more, as long as the aggregate average particle diameter of the catalyst carrier particle of the catalyst layer contacting the solid polymer electrolyte membrane is smaller than the aggregate average particle diameters of other catalyst layers, the aggregate average particle diameters of other catalyst layers may be selectable. However, it is advantageous for the diffusion of the gas and the water that the aggregate average particle diameter of the catalyst carrier particle is slightly smaller or the same size to the catalyst layer at the solid polymer electrolyte membrane side to improve the fuel cell performance. Further, even when the clear interface does not exist between the multiple layers of the catalyst layer and when the spatial distribution of the aggregate average particle diameter of the catalyst carrier particle exists in the thickness direction of the catalyst layer, it is identical to that the multiple catalyst layers are formed. In this case, the aggregate average particle diameter of the catalyst carrier particle of the portion contacting the solid polymer electrolyte membrane is the minimum.

Although the multiple catalyst layer construction is explained for the cathode in the embodiments, the multiple layers of the catalyst layer may be provided at the anode likewise the cathode. In this case, the improvement of the gas supply and the catalyst activation is attained likewise at the cathode. However, the fuel cell performance improves not by the discharge of the water vapor but by the supply of the water vapor. The fuel cell of the present invention improves the diffusion of the gas and the water at the catalyst layer of the cathode and the anode and the fuel cell performance is improved by the increase of the catalyst activation. Particularly, because the water is generated by the electrode reaction of the fuel cell at the cathode, the flooding phenomenon is restrained by the improvement of the discharge performance of the water, thus is more effective for the improvement of the fuel cell performance.

By forming the second catalyst layer on the first catalyst layer after forming the first catalyst layer on the gas diffusion layer member, the manufacturing process is simplified to reduce the manufacturing cost.

According to the embodiments of the present invention, with the fuel cell electrode assembled to the solid polymer electrolyte membrane, plural catalyst layers including the catalyst retaining particle corresponding to the catalyst carrier particles retained with the catalyst are stacked on the fuel cell electrode and the aggregate average particle diameter of the catalyst carrier particle of the catalyst layer contacting the solid polymer electrolyte membrane is smaller than the aggregate average particle diameter of the catalyst carrier particle of other catalyst layers. According to the embodiments of the present invention, the manufacturing method of the fuel cell electrode includes the first process for forming the first catalyst layer including the catalyst retaining particle corresponding to the catalyst carrier particles retained with the catalyst and the second process for forming the second catalyst layer on the first catalyst layer. The second catalyst layer includes the catalyst retaining particle corresponding to the catalyst carrier particles retained with the catalyst including the aggregate average particle diameter smaller than the aggregate average particle of the catalyst carrier particles of the first catalyst layer. Thus, the high performance fuel cell can be attained.

According to the embodiments of the present invention, the plural catalyst layers are provided at the electrode of the fuel cell and the aggregate average particle diameter of the catalyst carrier particle of the catalyst layer contacting the solid polymer electrolyte membrane is determined to be smaller than the aggregate average particle diameter of other catalyst layers. Thus, the ratio of the catalyst existing at the surface of the catalyst carrier particles at the catalyst layer contacting the solid polymer electrolyte membrane positioned approximate to the membrane-electrode interface where the electrode reaction is caused is high to attain the high catalyst activation. Further, because the aggregate average particle diameter of the catalyst carrier particle is larger at other catalyst layers, the small bore diameter can be determined larger to improve the diffusiveness of the gas and the water. Accordingly, the high diffusiveness of the gas and the water and the high catalyst activation can be attained to achieve the high performance fuel cell.

According to the embodiments of the present invention, by determining the aggregate average particle diameter of the catalyst carrier particle of the catalyst layers other than the catalyst layer contacting the solid polymer electrolyte membrane to be slightly smaller than or the same to the aggregate average particle diameter of the aggregate average particle diameter of the catalyst layer at the solid polymer electrolyte membrane side, the diffusiveness of the gas and the water can be further improved to further improve the fuel cell performance.

According to the embodiments of the present invention, the first catalyst layer includes high diffusiveness of the gas and the water because the aggregate particle diameter of the catalyst carrier particle is large at the first catalyst layer to provide the large small bore diameter. The second catalyst layer includes the large ratio of the platinum catalyst provided at the surface of the catalyst retaining particle to attain the high catalyst activation because the aggregate particle diameter of the catalyst carrier particle is small. Thus, the high diffusiveness of the gas and the water and the high catalyst activation can be attained by contacting the first catalyst layer to the solid polymer electrolyte membrane to achieve the high performance fuel cell.

According to the embodiments of the present invention, the manufacturing process is simplified because the second catalyst layer is formed on the first catalyst layer after forming the first catalyst layer on the gas diffusion layer member, which reduces the manufacturing cost.

According to the embodiments of the present invention, the assembling of the solid polymer electrolyte membrane and the second catalyst layer and the assembling of the membrane-electrode assembly can be processed with separate processes. Thus, the assembling suitable for the solid polymer electrolyte membrane and the second catalyst layer can be attained to provide the fuel cell with high performance.

According to the embodiment of the present invention, because the electrode for the fuel cell attaining the high fuel cell performance is used, the high performance fuel cell can be attained.

The principles, preferred embodiment and mode of operation of the present invention have been described in the foregoing specification. However, the invention which is intended to be protected is not to be construed as limited to the particular embodiments disclosed. Further, the embodiment described herein is to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

1. An electrode for fuel cell assembled to a solid polymer electrolyte membrane comprising:
catalyst carrier particles;
catalyst retaining particles formed by retaining a catalyst at the catalyst carrier particles;
at least two laminated catalyst layers including the catalyst retaining particle; wherein
an aggregate average particle diameter of the catalyst carrier particle of one of the catalyst layers contacting the solid polymer electrolyte membrane is smaller than aggregate average particle diameters of the catalyst carrier particle of another of the catalyst layers.

2. The electrode for fuel cell according to claim 1, wherein the aggregate average particle diameter of the catalyst carrier particle of the plural catalyst layers is slightly smaller than or the same size to the aggregate average particle diameter of the catalyst carrier of the catalyst layer at the solid polymer electrolyte membrane side.

3. A manufacturing method of an electrode for fuel cell comprising:
a first process for forming a first catalyst layer including catalyst retaining particles including catalyst carrier particles retained with a catalyst; and
a second process for forming a second catalyst layer including catalyst retaining particles including catalyst carrier particles retained with a catalyst on the first catalyst layer, the catalyst carrier particles including an aggregate average particle diameter smaller than an aggregate average particle diameter of the catalyst carrier particle of the first catalyst layer.

4. The manufacturing method of the electrode for fuel cell according to claim 3, wherein the first catalyst layer is formed at a gas diffusion layer member including gas diffusiveness and electric conductivity at the first process; and wherein the second catalyst layer is formed on the first catalyst layer formed at the gas diffusion layer member.

5. The manufacturing method of the electrode for fuel cell according to claim 3, wherein the first catalyst layer is formed at a gas diffusion layer member including gas diffusiveness and electric conductivity at the first process; and wherein the second catalyst layer is formed on the first catalyst layer by arranging the first catalyst layer and the second catalyst layer to face each other to be assembled after forming the second catalyst layer on a solid polymer electrolyte membrane at the second process.

6. A fuel cell comprising:
an anode provided at a first side of a solid polymer electrolyte membrane;
a cathode provided at a second side of the solid polymer electrolyte membrane; wherein at least one of the anode and the cathode comprises
catalyst carrier particles;
catalyst retaining particles formed by retaining a catalyst at the catalyst carrier particles;
a plurality of catalyst layers including the catalyst retaining particle; wherein
an aggregate average particle diameter of the catalyst carrier particle of the catalyst layer contacting the solid polymer electrolyte membrane is smaller than aggregate average particle diameters of the catalyst carrier particle of other catalyst layers.

7. The fuel cell according to claim 6, wherein the aggregate average particle diameter of the catalyst carrier particle of the plural catalyst layers is slightly smaller than or the same size to the aggregate average particle diameter of the catalyst carrier of the catalyst layer at the solid polymer electrolyte membrane side.

8. A fuel cell comprising:
an anode provided at a first side of a solid polymer electrolyte membrane;
a cathode provided at a second side of the solid polymer electrolyte membrane; wherein at least one of the anode and the cathode is manufactured by a method comprising:
a first process for forming a first catalyst layer including catalyst retaining particles including catalyst carrier particles retained with a catalyst; and
a second process for forming a second catalyst layer including catalyst retaining particles including catalyst carrier particles retained with the catalyst on the first catalyst layer, the catalyst carrier particles including an aggregate average particle diameter smaller than an aggregate average particle diameter of the catalyst carrier particle of the first catalyst layer.

9. A fuel cell according to claim 8, wherein the first catalyst layer is formed at a gas diffusion layer member including gas diffusiveness and electric conductivity at the first process; and wherein the second catalyst layer is formed on the first catalyst layer formed at the gas diffusion layer member.

10. A fuel cell according to claim 8, wherein the first catalyst layer is formed at a gas diffusion layer member including gas diffusiveness and electric conductivity at the first process; and wherein the second catalyst layer is formed on the first catalyst layer by arranging the first catalyst layer and the second catalyst layer to face each other to be assembled after forming the second catalyst layer on a solid polymer electrolyte membrane at the second process.
